(19) United States
(12) Patent Application Publication
(10) Pub. No.: US 2024/0354807 A1
(43) Pub. Date: Oct. 24, 2024

(54) Providing Destination-Specific Electronic Offerings Through an Inflight Entertainment System Onboard an Aircraft

(71) Applicant: ViaSat, Inc., Carlsbad, CA (US)

(72) Inventors: Ultan O’Brien, Carrickmines (IE); Niall O'Sullivan, Dundrum (IE); Fergal Murray, Tomhaggard (IE)

(21) Appl. No.: 18/684,673

(22) PCT Filed: Aug. 19, 2022
(86) PCT No.: PCT/US22/40968

§ 371 Date: Feb. 17, 2024

Related U.S. Application Data
(60) Provisional application No. 63/235,672, filed on Aug. 20, 2021.

(51) Int. Cl. G06Q 30/0251

(52) U.S. Cl. CPC G06Q 30/0265; G06Q 30/0252; G06Q 30/0261; G06Q 30/0269

(57) ABSTRACT

Technology is described for providing electronic offering items to passengers on an aircraft. In one example of the technology, destination information may be obtained from an aircraft data bus that receives aircraft flight information from a plurality of aircraft information systems located on the aircraft. The destination information may be sent to a vendor application programming interface (API) to obtain at least one electronic offering item associated with the destination information to display in an inflight entertainment system. An electronic offering item may be received via the vendor API, and the electronic offering item may be sent to a client device to be displayed via the inflight entertainment system. A graphical interface of the inflight entertainment system at the client device may enable a passenger on the aircraft to interact with the electronic offering item.

### BACKGROUND

Inflight entertainment and information systems may provide entertainment, moving map information, flight information, or other information to aircraft passengers during a flight. Inflight entertainment systems may include centralized display monitors, seat back display monitors and/or wireless connections for personal electronic devices via a wireless network, which may enable aircraft passengers to consume audio content, video content, moving map information, electronic games, etc. The media content can include music, news, comedy, moving map information, flight information, travel information, etc. Such video content can include television programs, movies, live television programs (e.g., live news programs, live sporting events), cable programs, etc. Moving map information may provide real-time flight information. For example, the moving map information may provide a map that illustrates a current position and direction of the aircraft, as well as other information about the flight (e.g., altitude, airspeed, outside air temperature, distance to destination, distance from origination point, local time, etc.)

In one example, inflight entertainment systems can provide in-flight network connectivity to personal electronic devices, such as mobile phones, laptops, or tablet computers. For example, inflight entertainment systems may allow aircraft passengers to consume audio content, video content, games, maps, etc. using personal electronic devices. The personal electronic devices can receive the audio content, video content, games, maps, shopping, etc. from a server onboard the aircraft via a wireless access point (e.g., a Wi-Fi access point) in the aircraft. Further, inflight entertainment systems may provide in-cabin internet service, allowing aircraft passengers to perform activities, such as internet browsing, media viewing, texting, messaging, emailing, using web enabled applications, etc. using their personal electronic devices. A satellite network wirelessly linked with communications hardware on the aircraft can provide in-flight internet service that enables aircraft passengers to connect to the internet from personal electronic devices via the wireless access point.

### SUMMARY

A system is described for providing electronic offering items to passengers on an aircraft. The system may include at least one processor and a memory device including instructions that, when executed by the at least one processor, may cause the system to obtain destination information from an aircraft data bus, wherein the destination information is from a plurality of aircraft information systems located on the aircraft. The instructions, when executed by the at least one processor, may cause the system to send the destination information to at least one vendor application programming interface (API) to obtain at least one electronic offering item for display in an inflight entertainment system. The instructions, when executed by the at least one processor, may cause the system to receive the at least one electronic offering item selected to be displayed in the inflight entertainment system, where the at least one electronic offering item is selected based in part on the destination information. The instructions, when executed by the at least one processor, may cause the system to send the at least one electronic offering item to a client device to be displayed via the inflight entertainment system. A graphical interface of the inflight entertainment system at the client device may enable a passenger on the aircraft to interact with the at least one electronic offering item.

A method is described for providing electronic offering items to passengers on an aircraft. The method may include obtaining destination information from an aircraft data bus, and the destination information may be from a plurality of aircraft information systems located on the aircraft. The method may include sending the destination information to a vendor application programming interface (API) to obtain at least one electronic offering item for display on a client device in an inflight entertainment system. The method may include receiving the selected at least one electronic offering item via the vendor API to be displayed on a client device in the inflight entertainment system. At least one electronic offering item is selected based in part on the destination information. The method may include sending at least one electronic offering item to a client device to be displayed via the inflight entertainment system, where a graphical interface of the inflight entertainment system at the client device may enable a passenger on the aircraft to interact with at least one electronic offering item.

A non-transitory machine readable storage medium including instructions embodied thereon is provided. The instructions, when executed by at least one processor may obtain destination information from an aircraft data bus, and the destination information may be obtained from a plurality of aircraft information systems located on the aircraft. The instructions, when executed by the at least one processor may send the destination information to a vendor interface to obtain at least one electronic offering item for display in an inflight entertainment system, wherein at least one electronic offering item is selected based in part on the destination information. The instructions, when executed by the at least one processor may receive the selected at least one electronic offering item to be displayed in the inflight entertainment system. The instructions, when executed by the at least one processor may send at least one electronic offering item to a client device to be displayed via the inflight entertainment system, where a graphical interface of the inflight entertainment system at the client device may enable a passenger on the aircraft to interact with at least one electronic offering item.

### BRIEF DESCRIPTION OF THE DRAWINGS

FIG. 1 is a block diagram illustrating an example system for providing destination-specific electronic offering items to passengers on an aircraft.

FIG. 2 is a block diagram illustrating an example system for providing destination-specific electronic offering items to passengers on an aircraft using passenger profiles.

FIG. 3 is a block diagram illustrating an example system for providing an inflight entertainment system capable of displaying destination-specific electronic offering items to client devices.

FIGS. 4A-C are diagrams illustrating an example inflight entertainment system with an interface that enables a passenger to navigate to destination-specific electronic offering items.

FIG. 5 is a flow diagram illustrating an example method for providing destination-specific electronic offering items to passengers on an aircraft.

FIG. 6 is a flow diagram illustrating another example method for providing cached electronic offering items to passengers on an aircraft when a vendor server is not available.

FIG. 7 is a block diagram illustrating a satellite communication system according to an example of the present technology.

FIG. 8 is a block diagram that provides an example illustration of a computing device that may be employed in the present technology.

### DETAILED DESCRIPTION

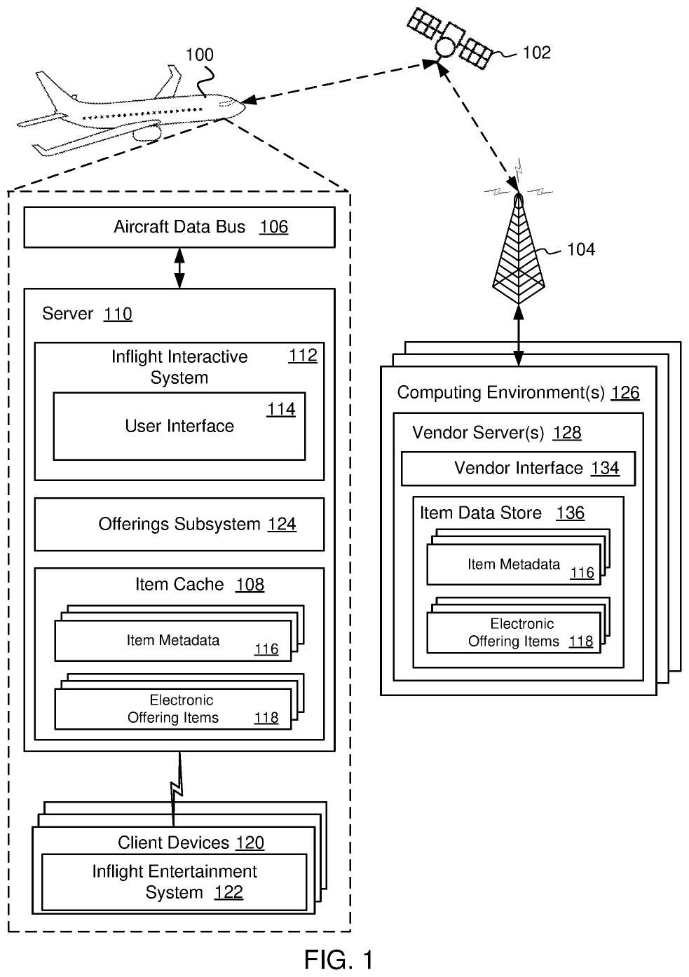

FIG. 1 is a block diagram illustrating one example of a system located onboard an aircraft 100 for obtaining a plurality of electronic offering items 118 associated with a specific destination from a plurality of vendor servers 128 and providing the electronic offering items 118 to passengers through an inflight entertainment system 122. A destination may be a physical destination such as a city, an airport, a locale, a resort, a landmark, etc. In some embodiments, the destination is associated with a particular geographical location or area. An electronic offering item 118 can include: a web page, an application page, an electronic document, an electronic object, a commercial listing in an electronic page, and the like. The electronic offering item 118 may provide information about a product, service, etc., available at a destination and may allow a passenger on the aircraft 100 to purchase the product, service, etc., prior to arriving at the destination. The electronic offering items 118 can be organized into categorized groupings of offers and displayed in a graphical user interface of the inflight entertainment system 122 accordingly. The aircraft 100 may be one of multiple aircraft which are included in a fleet of aircraft. A server 110 onboard the aircraft 100 may include an inflight interactive system 112 configured to provide passengers with the inflight entertainment system 122.

Passengers of the aircraft 100 can access the inflight entertainment system 122 using client devices 120. The inflight interactive system 112 may include a user interface 114 to allow passengers (or users) to access the inflight entertainment system 122. Illustratively, the user interface 114 enables the passengers on the aircraft 100 to view movies and television programs, listen to audio programming, play electronic games, browse shopping electronic pages, and the like via the inflight interactive system 112. The services available through the inflight entertainment system 122 enable passengers to view electronic offering items 118 that can promote destination-specific products, services, information, etc.

As illustrated, the server 110 includes an offerings subsystem 124 to perform requests for a plurality of electronic offering items 118 associated with a destination and provide the electronic offering items 118 to passengers traveling to the destination through the inflight entertainment system 122. In one example configuration, the offerings subsystem 124 obtains destination information from an aircraft data bus 106 (i.e., an avionics data bus) of the aircraft 100 in which the server 110 is installed to send to one or more vendor servers 128 along with a request for electronic offering items 118 which are related to the destination information. The destination information obtained by the offerings subsystem 124 from the aircraft data bus 106 includes an aircraft destination (e.g., a destination airport or destination city). In examples described later, the destination information can include a passenger's further or final destination to which the passenger may continue to travel after arriving at the destination of the aircraft 100. The aircraft data bus 106 may receive aircraft flight information, including the destination information, from a plurality of aircraft information systems, including navigation, weather systems, communications, aircraft networks, and other avionics located on the aircraft 100. In some embodiments, the aircraft flight information available from the aircraft data bus 106 is information that is specific to the aircraft 100. As an example, the aircraft flight information may include: an aircraft origin, an aircraft destination, an estimated arrival time, an arrival gate, a current latitude and longitude of the aircraft, a current aircraft speed, a current aircraft altitude, a seatbelt warning status, a passenger service status, an origin weather report, as well as other information available from the aircraft information systems. The aircraft information systems located on the aircraft 100 may communicate the aircraft flight information to each other using the aircraft data bus 106. In some embodiments, the destination information for the aircraft 100 comprises one or more of the aircraft destination, an estimated arrival time, an arrival gate, destination weather information, and any other information related to the destination that is available to systems on the aircraft 100.

In one example, the offerings subsystem 124 sends the destination information to one or more vendor servers 128 using vendor application programming interfaces (APIs), or similar interfaces, for individual vendor servers 128. The vendor servers 128 may be located off the aircraft 100 in computing environments 126 (e.g., private cloud environments, a data center, centralized hardware servers, a data warehouse, public cloud environments, terrestrial environments, etc.), and communication between the offerings subsystem 124 and the vendor servers 128 can be performed over a satellite network that includes a satellite 102 and a ground station 104 in network communication with other types of computer networks. The vendor servers 128 may manage electronic offering items 118 stored in item data stores 136 on behalf of one or more vendors. A vendor can be a business, organization, group, individual, or other third-party that has their destination-specific products, services, and/or information offered through the inflight interactive system 112. The electronic offering item 118 can be a web page, an application page, an electronic document, an electronic object, and the like stored on a vendor server 128. The electronic offering item 118 can contain one or more of: text, images, electronic links, audio, animations, games, video, etc. The electronic offering item 118 may be interactive such that a passenger can interact with the electronic offering item 118. Item metadata 116 or tags can be assigned to the electronic offering item(s) 118. The item metadata 116 may comprise information describing the electronic offering item 118. For example, the item metadata 116 may describe or comprise one or more of a vendor, a product, a service, search keywords, or other content related to the electronic offering item 118. The item metadata 116 can include information that links an electronic offering item 118 with the destination information of the aircraft 100, such as an address, city, zip code, area code, landmark, and other types of location identifying information. As a non-limiting example, the item metadata 116 for the electronic offering item 118 that features a hotel can include an address of the hotel (e.g., Via Marsala, Roma, Italy) which can be linked to the destination of the aircraft 100 (e.g., Rome-Fiumicino International Airport).

The vendor servers 128 may receive requests for the electronic offering items 118 associated with a destination (e.g., a city), and the vendor servers 128 may respond by providing the electronic offering items 118 in response to the requests. The vendor servers 128 can be in various computing environments 126 (e.g., private cloud environment, data center, centralized hardware servers, data warehouse, public cloud, etc.) and the vendor server 128 may be associated with a particular vendor. A vendor interface 134 for the vendor server 128 can include a vendor API configured to receive the destination information sent from the server 110 onboard the aircraft 100. The destination information can be provided as a parameter in an API call made by the offerings subsystem 124. In response to receiving the destination information, the vendor API determines whether one or more electronic offering item(s) 118 have item metadata 116 that links electronic offering item(s) 118 with the destination information. In the case that an electronic offering item 118 is identified, the vendor API sends the electronic offering item 118 over the satellite network including the satellite 102 and the ground station 104 to the server 110 on the aircraft 100. The item metadata 116 for the electronic offering item 118 can also be sent to the server 110 to allow the offerings subsystem 124 to use the item metadata 116 to categorize and group electronic offering items 118. In some embodiments, the server 110 may update the item metadata 116 for one or more of the electronic offering items 118, for example, based on input from a passenger, popularity/selection rate information, and so forth.

The offerings subsystem 124 can be configured to request electronic offering items 118 from the vendor servers 128 at any time, including prior to takeoff, during the flight, and after landing (e.g., during a time in which passengers are waiting to disembark the aircraft 100). The electronic offering items 118 obtained by the offerings subsystem 124 may be presented to a user (e.g., a passenger) using the inflight entertainment system 122. In one example configuration, the offerings subsystem 124 can evaluate aircraft flight information (for example, via the aircraft data bus 106) to determine a current status of the flight (e.g., parked at a gate, in takeoff, in-flight, or in landing) and determine whether to obtain an electronic offering item 118 for display in the inflight entertainment system 122 based in part on the current status of the flight. As one example, the offerings subsystem 124 may request electronic offering items 118 from the vendor servers 128 when the aircraft 100 is on the ground or at a gate due to increased costs associated with receiving data when the aircraft 100 is inflight. As another example, in order to provide passengers with the most up-to-date offers, the offerings subsystem 124 may wait to request electronic offering items 118 from the vendor servers 128 until the aircraft 100 is within a distance (e.g., 100 miles) of the aircraft destination. As yet another example, the current status of the flight may indicate a change in destination due to weather or some other event, and the offerings subsystem 124 can obtain an updated set of electronic offering items 118 from the vendor servers 128 using the new destination. In some embodiments, the offering subsystem 124 may monitor for changes in the aircraft information, such as the aircraft destination, arrival time, etc., and use such changes to trigger obtaining an updated set of electronic offering items 118 from the vendor servers 128.

In one example, the server 110 may include an item cache 108 and the offerings subsystem 124 may temporarily store the electronic offering items 118 in the item cache 108 for a duration or a portion of the flight. The inflight interactive system 112 may access the item cache 108 and retrieve the electronic offering items 118 for display in the inflight entertainment system 122. In one example, the offerings subsystem 124 can periodically update the item cache 108 with current electronic offering items 118 and item metadata 116 obtained from the vendor servers 128. The period for update might be a number of minutes, a number of hours, an amount of distance traveled by a plane, a change in time zones, change in aircraft information, distance from aircraft destination, beginning of landing, etc. In some embodiments, during times that communication with the vendor servers 128 cannot be established via the satellite (or other) network, the inflight interactive system 112 can obtain electronic offering items 118 stored on the aircraft 100 from the item cache 108.

The offerings subsystem 124 can organize electronic offering items 118 received from the vendor servers 128 into categorized groupings of offers provided to passengers via the inflight entertainment system 122. The offerings subsystem 124 can associate an electronic offering item 118 with a categorized grouping of offers using item metadata 116 received from the vendor servers 128. For example, the electronic offering items 118 may include offers from a variety of categories, such as events, attractions, shopping, museums, lodging, restaurants, transportation, travel information, etc., and each category may include sub-categories. As a non-limiting example, an attractions category can include tours, entrance tickets, gift shops and the like for one or more of monuments, amusement parks, zoos, and so forth. As another non-limiting example, a lodging category can include options for lodging, such as hotels, motels, bed and breakfasts, and the like. The offerings subsystem 124 can evaluate the item metadata 116 for the electronic offering item 118 and assign the electronic offering item 118 to a corresponding categorized grouping. In some embodiments, each electronic offering item 118 may be assigned to one or more categories.

The inflight interactive system 112 may send, broadcast, transmit, or otherwise make available the inflight entertainment system 122 to the client device 120 onboard the aircraft 100. The inflight interactive system 112 can generate the user interface 114, which can include a graphical user interface (GUI) of a web application that can be sent to the client devices 120. The user interface 114 may include interface controls to access a home screen, media content, shopping information, aircraft information, and the like. Furthermore, the user interface 114 for the inflight entertainment system 122 can provide access to the destination-specific categorized groupings of electronic offering items 118. For example, the user interface 114 may include an electronic link, a tab, a button, a menu item, a list, or other interface control tied to the categorized groupings of electronic offering items 118.

A passenger can browse the various destination-specific categorized groupings of electronic offering items 118 using the client device 120. The client device 120 may comprise, for example, processor-based systems. More specifically, the client device 120 may be a personal electronic device, such as, but not limited to, a mobile phone, a laptop or notebook computer, a tablet computer, a handheld computer or mobile computing device, or any other device with similar capabilities. The client device 120 may be a personal electronic device or may be property of an aircraft operator. In another example, the client device 120 may be a seatback system installed on a passenger seat of the aircraft 100.

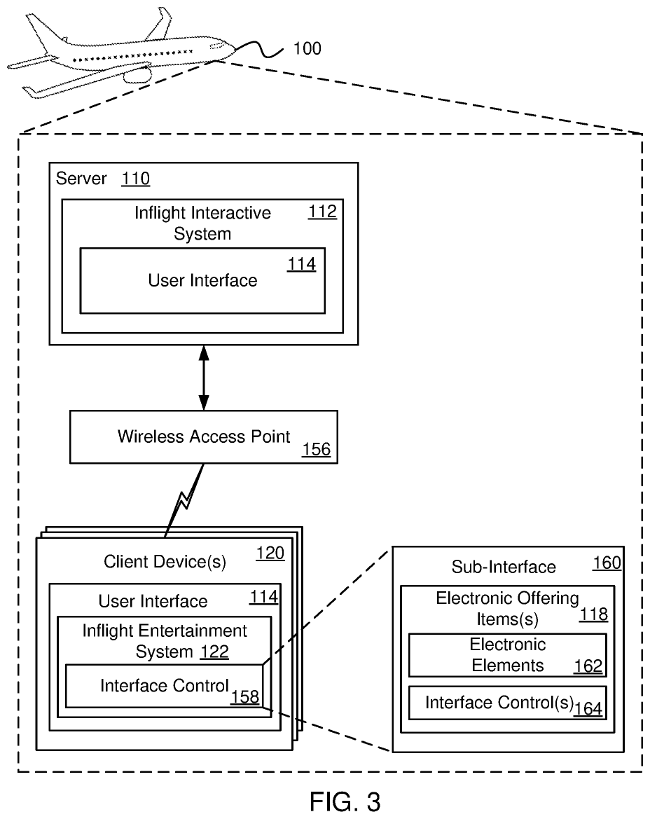

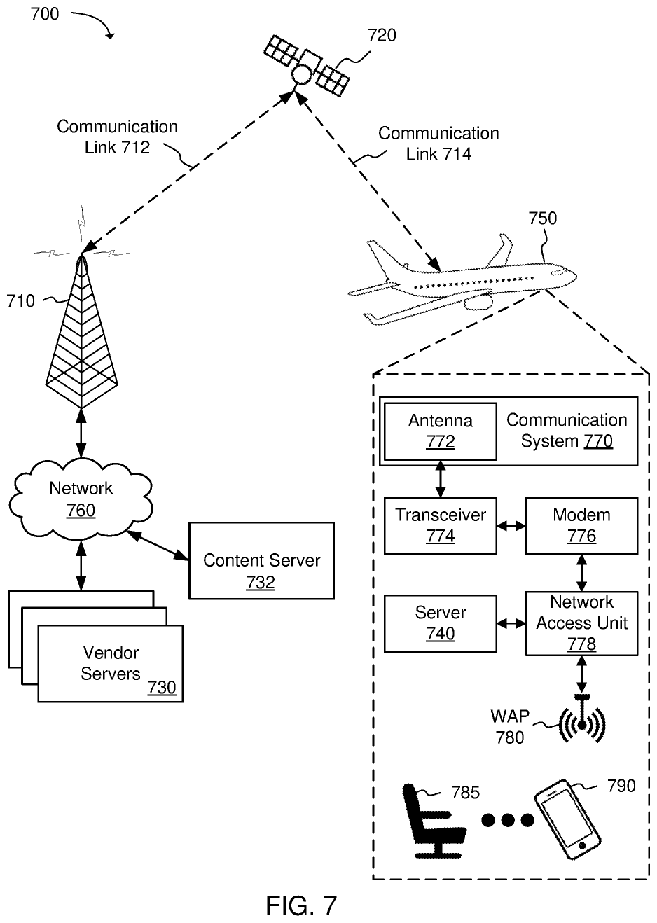

In one configuration, the server 110 may communicate with the client device(s) 120 via a network. The network may include any useful computing network, including a localized network, a wired data network, a wireless data network, or any other such network or combination thereof. For example, a connection between the client device 120 and the server 110 may be a wireless connection established via a wireless access point (shown in FIG. 7) or a wired connection. Components utilized for such a system may depend at least in part upon the type of network and/or environment selected. In one example, the wireless connection between the server 110 and the client device(s) 120 may be established using Transmission Control Protocol/Internet Protocol (TCP/IP), and services in the server 110 may be web services that are RESTful. A wireless access point (shown as wireless access point 156 in FIG. 3 and WAP 780 in FIG. 7) that facilitates data traffic between the server 110 and the client device(s) 120 may operate using a WI-FI protocol, a BLUETOOTH protocol, or another appropriate wireless protocol.

The passenger, via the client device 120, can select one or more of the destination-specific categorized groupings (e.g., products) and be presented with one or more electronic offering items 118 that fall within the categorized grouping(s) (e.g., products, services, etc., that are available at a destination). As described earlier, the electronic offering items 118 may include a plurality of electronic elements 162 (e.g., electronic links, web pages, application pages, text, images, audio or video, apps, animations, plugins, etc.) and/or interface controls used to provide information about a product, service, etc., available at the destination from a vendor or provide information related to the destination (e.g., travel advisory, customs regulations, travel tips, etc.). The passenger, while in route to the destination, can view the vendor information in the electronic offering item 118, view information related to the electronic offering item 118, and in some cases purchase the product, service, etc., featured in the electronic offering item 118.

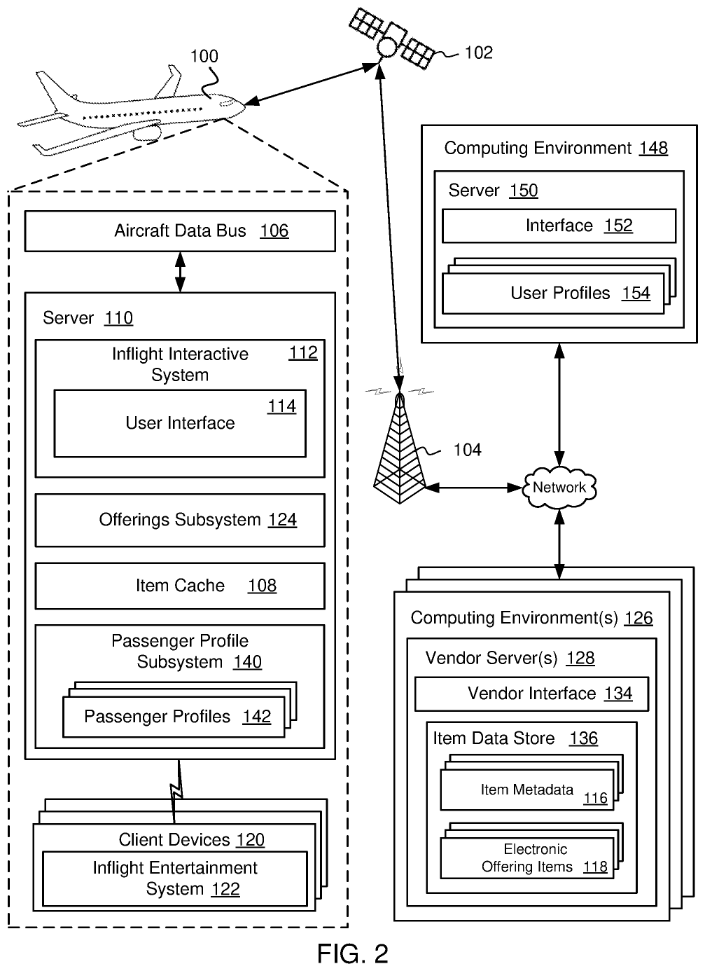

FIG. 2 is a block diagram illustrating another example of a system that utilizes a number of additional subsystems to provide personalized or targeted destination-specific electronic offering items 118 to passengers on an aircraft 100. A server 110 located onboard the aircraft 100 may operate a passenger profile subsystem 140 configured to obtain passenger information for passengers on the aircraft 100. Passenger information for a passenger may be used to identify destination-specific electronic offering items 118 for products, services, or information that may be of interest to the passenger.

In one example, the passenger profile subsystem 140 may create a passenger profile 142 for a passenger on the aircraft 100 based on input (e.g., user profile information) received from a client device 120 associated with the passenger. For example, the passenger profile subsystem 140 may receive demographic information, itinerary information, and/or interest information from the client device 120 and use this information to create the passenger profile 142. In one example, a passenger may provide passenger information during a flight by inputting the passenger information into the user interface 114 of the inflight interactive system 112. For example, the user interface 114 may prompt a passenger to provide passenger information using a series of questions, checkboxes, forms, etc. The passenger profile subsystem 140 may receive passenger information input by a passenger and create a locally stored passenger profile 142 for the passenger.

Additionally, or alternatively, the passenger profile subsystem 140 may obtain a user profile 154 or other information (e.g., itinerary information, etc.) associated with a passenger from an offboard server 150 associated with, for example, an aircraft operator or other third party entity. The server 150 may be located in a computing environment 148 (e.g., a private cloud environment, a public cloud environment, a data center, centralized hardware servers, a data warehouse, etc.). The server 150 may manage user profiles 154 or other itinerary or similar information for customers (e.g., passengers) of the aircraft operator. The user profiles 154 or other information may include demographic information, itinerary information, customer interest information, etc. The server 150 may make the user profiles 154 or other information available to the passenger profile subsystem 140. For example, the server 150 may include an interface 152, such as an API, and the passenger profile subsystem 140 may send a request to the API that includes identifying information for a passenger (e.g., customer number, seat and flight number, name, frequent flyer number, etc.). In response to receiving the request, the server 150 may identify a user profile 154 or other information associated with the identifying information, and the API may send the user profile 154 or other information to the server 110 located onboard the aircraft 100 to allow the passenger profile subsystem 140 to create a locally stored passenger profile 142 using the information in the user profile 154 or the other information.

In addition to demographic information, itinerary information, and/or customer interest information, the user profile 154 or other information obtained from the offboard server 150 can include previous electronic activities of the passenger while onboard previous flights, such as products purchased in-flight, movies or music consumed by the passenger, advertisements interacted with by the passenger, websites visited by the passenger, etc. The information received from the server 150 can be used to create a passenger profile 142 for the passenger for use during a current flight. The passenger profile subsystem 140 may update the passenger profile 142 during the flight to include electronic activities of the passenger while currently onboard the aircraft 100. Also, the passenger profile subsystem 140 can send the electronic activities or other passenger profile updates of the passenger to the off-board server 150 to the offboard server 150 (e.g., during or after the current flight) so that the server 150 can update the passenger's user profile 154 managed by the offboard server 150 accordingly.

Passenger profiles 142 created by the passenger profile subsystem 140 may be made available to the offerings subsystem 124. As indicated above, a passenger profile 142 may include itinerary information specifying a final destination for a passenger. The passenger destination specified in the passenger profile 142 may be different from a destination of an aircraft 100 obtained from the aircraft data bus 106. More specifically, the destination obtained from the aircraft data bus 106 may be a destination of the aircraft 100 and not the final destination of the passenger onboard the aircraft 100. For example, after arriving at the aircraft destination, the passenger may take a connecting flight or other transportation (e.g., train or car) to the passenger's final destination. Accordingly, the offerings subsystem 124 may obtain the passenger's final destination from the passenger profile 142, and the offerings subsystem 124 may use the passenger's final destination to identify electronic offering items 118 associated with the passenger's final destination instead of the aircraft destination and provide these electronic offering items 118 to the passenger via the inflight entertainment system 122.

The offerings subsystem 124 can use other types of passenger information (e.g., demographic information, customer interest information, onboard activity information, etc.) obtained from the passenger profile 142 to identify electronic offering items 118 that may be of interest to the passenger based on the passenger information. In one example, the offerings subsystem 124 may send the passenger information obtained from the passenger profile 142, along with destination information (e.g., aircraft destination and/or passenger's final destination) to the vendor servers 128 described earlier. The vendor servers 128 may use the passenger information and the destination information to identify destination-specific electronic offering items 118 having item metadata 116 that corresponds to the passenger information. The vendor servers 128 may then return the destination-specific electronic offering items 118 to the server 110, making the electronic offering items 118 available to the offerings subsystem 124. Thus, the offerings subsystem 124 may use the passenger information to provide customized or passenger specific electronic offering items 118. As an example, a passenger profile 142 may indicate that a passenger prefers to stay at hotels that cater to business travelers. The offerings subsystem 124 may send an API request to the vendor servers 128 for electronic offering items 118 that feature hotels with business amenities at the destination. The vendor servers 128 may identify electronic offering items 118 for hotels at the destination that offer the business amenities and send the electronic offering items 118 to the server 110 to allow the offerings subsystem 124 to provide the electronic offering items 118 to the passenger via the inflight entertainment system 122.

In another example, the offerings subsystem 124 may use passenger information obtained from the passenger profile 142 to identify locally stored electronic offering items 118 that may be of interest to the passenger. For example, the offerings subsystem 124 can query the item cache 108 described earlier using the passenger information to identify electronic offering items 118 that have item metadata 116 that corresponds to the passenger information. Additionally, in one example, electronic offering items 118 that have been identified using passenger information from the passenger profile 142 may be sent to the passenger associated with the passenger profile 142 through the inflight entertainment system 122. For example, a vendor associated with an electronic offering item 118 can elect to have the electronic offering item 118 sponsored when passenger information indicates that the passenger may be interested in the vendor's products and/or services. The offerings subsystem 124 may sponsor an electronic offering item 118 by placing the electronic offering item 118 before other electronic offering items 118 in a categorized grouping, by emphasizing the electronic offering item 118 in some way (e.g., using bold text, bright color scheme, animations, etc.), and so forth.

In one example configuration, the offerings subsystem 124 may provide destination-specific electronic offering items 118 to passengers at particular times or events during a flight. For example, some products, services, and information included in electronic offering items 118 may be more relevant to passengers at particular times during a flight. As one example, electronic offering items 118 related to food available at a destination may be of more interest to passengers around or after a time that snacks or meals are being distributed to passengers. As another example, passengers may be interested in viewing electronic offering items 118 featuring tours and excursions after watching a travel show through the inflight entertainment system 122 or after awakening from a rest period.

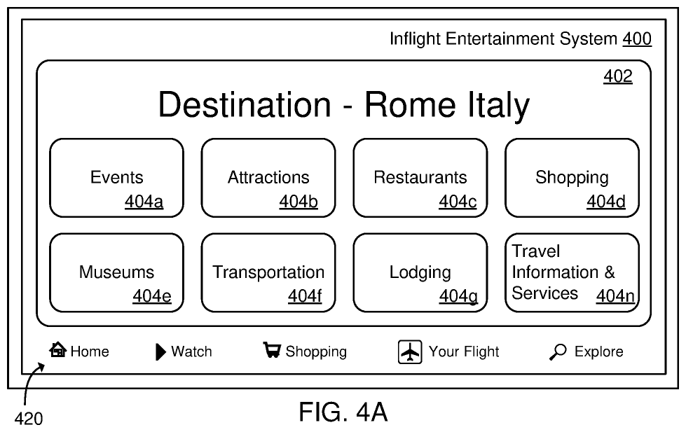

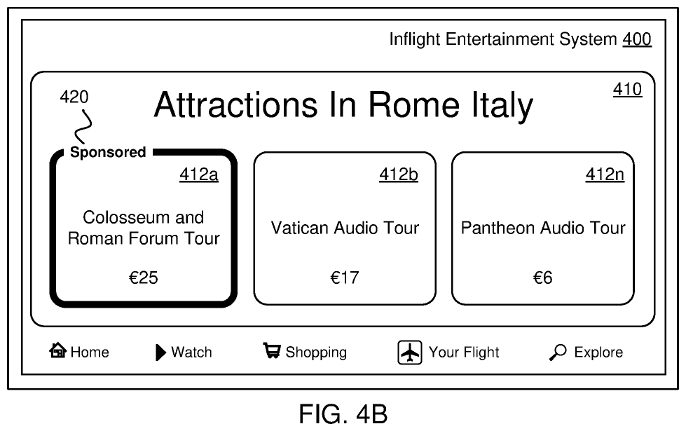

Accordingly, in one example, the offerings subsystem 124 may monitor aircraft flight information obtained from the aircraft data bus 106 for events that may correspond to an opportunity to promote an electronic offering item 118 to passengers. As an example, the offerings subsystem 124 may monitor an aircraft latitude and longitude, an aircraft altitude, a seatbelt warning status, an announcement related to turbulence, safety, food service, a weather report, an estimated arrival time, an arrival gate, detour information, etc. In response to detecting an event (e.g., an announcement that a meal service is starting), the offerings subsystem 124 may obtain an electronic offering item 118 featuring a product, service, or information (e.g., destination restaurants) which may be of interest to passengers on the aircraft 100 before, during or after the event, and the offerings subsystem 124 may provide the electronic offering item 118 to the inflight entertainment system 122 to allow the passengers to view the electronic offering item 118. The offerings subsystem 124 may obtain the electronic offering item 118 from the offboard vendor servers 128 or from the on-board item cache 108. Item metadata 116, such as a key-value pair, which associates the electronic offering item 118 with the event, may be assigned to the electronic offering item 118, and the offerings subsystem 124 may use the item metadata 116 to identify the electronic offering item 118 when the event is detected. The offerings subsystem 124 may sponsor the electronic offering item 118 by placing the electronic offering item 118 before other electronic offering items 118 contained in a categorized grouping, emphasize the electronic offering item 118 in some way, such as using bold text, a bright color scheme, animations, etc., and so forth For example, as illustrated in FIG. 4B, a link 420 to an electronic offering item can be sponsored by highlighting the link 420 to the electronic offering item displayed in an inflight entertainment system interface 400.

Referring again to FIG. 2, in one example, passenger interaction with the inflight entertainment system 122 can be captured. For example, interaction data associated with passenger activities such as purchasing products or services, viewing movies and shows, playing video games, browsing the internet, etc. can be generated and the interaction data can be saved to a local passenger profile 142 associated with the passenger. In one example, the interaction data can also be sent to the server 150 to update the user profile 154 of the passenger with the interaction data. The offerings subsystem 124 may monitor passenger interaction with the inflight entertainment system 122 and identify an electronic offering item 118 that corresponds to the passenger interaction. As an example, the offerings subsystem 124 may monitor media (e.g., inflight video program or show) viewed by a passenger and determine whether metadata for the media corresponds to item metadata 116 for a destination-specific electronic offering item 118. As a specific example, metadata for a video program viewed in the inflight entertainment system 122 may specify a pizza restaurant located at a destination city featured in the movie, and the offerings subsystem 124 can use the metadata to identify an electronic offering item 118 for the pizza restaurant and display the electronic offering item 118 to the passenger in the inflight entertainment system 122.

FIG. 3 is a block diagram illustrating an example of a system for providing an inflight entertainment system 122 via the inflight interactive system 112 to the client devices 120. As described earlier, the server 110 onboard the aircraft 100 may provide a user interface 114 to the client devices 120. The user interface 114 may enable access to both the inflight entertainment system 122 and one or more electronic offering items 118. The inflight entertainment system 122 may enable a passenger on the aircraft 100 to watch movies and television programs, listen to audio, play electronic games, browse electronic shopping pages, etc. The inflight entertainment system 122 may include an interface control 158 to, for example, enable the passenger to navigate the inflight entertainment system 122 and access and interact with categorized groupings of destination-specific electronic offering items 118 (e.g., a marketplace). The interface control 158 may be a graphical user interface (GUI) control, including but not limited to, an electronic link, a tab, a button, menu item, etc., where the interface control 158 may be used to access the categorized groupings of destination-specific electronic offering items 118.

An electronic offering item 118 may include a plurality of electronic elements 162 (e.g., electronic links, web pages, application pages, text, images, audio or video, apps, animations, plugins, etc.) and/or interface controls 164. The electronic offering item 118 may be displayed through a sub-interface 160 provided to the client device 120. For example, the passenger selecting the interface control 158 on the inflight entertainment system 122 displayed through the user interface 114 may cause a categorized grouping of electronic offering items 118 to be opened and displayed through the sub-interface 160. Furthermore, selection by the passenger of an individual electronic offering item 118 from a categorized group electronic offering items 118 may cause the selected electronic offering item 118 to be opened and displayed through the sub-interface 160. In some embodiments, the passenger may select multiple electronic offering items 118 and the sub-interface 160 may provide a view that displays and/or compares each of the selected electronic offering items 118.

In the examples described herein, techniques, systems, methods, etc. are described in the context of an aircraft. Alternatively, the techniques, systems, methods, etc. described may be provided to a client device 120 on another type of transportation, such as a ship, bus, train, etc.

The various processes and/or other functionality contained within or performed by the server(s) 110 may be executed on one or more processors that are in communication with one or more memory modules. The server(s) 110 may include a number of computing devices that are arranged, for example, in one or more server banks or computer banks or other arrangements.

The term “data store” may refer to any device or combination of devices capable of storing, accessing, organizing and/or retrieving data, which may include any combination and number of data servers, relational databases, object-oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

FIGS. 1-3 illustrate that certain processing modules or subsystems may be discussed in connection with this technology. In one example configuration, a module or subsystem may be considered a service with one or more processes executing on a server or other computer hardware. For example, modules or subsystems providing services may be hosted in a server. An application programming interface (API) may be provided for each module or subsystem to enable a second module or subsystem to send requests to and receive output from a first module or subsystem. Such APIs may also allow third parties to interface with the module or subsystem and make requests and receive output from the modules or subsystems. While FIGS. 1-3 illustrate examples of systems that may implement the techniques above, many other similar or different environments are possible. The example environments discussed and illustrated above are merely representative and not limiting.

Referring generally to FIGS. 4A-C, an example inflight entertainment system is illustrated as having an interface 400 that enables a passenger to access inflight entertainment system features 420 (e.g., media, shopping, flight information, etc.) and a plurality of sub-interfaces used to navigate to destination-specific electronic offering items. FIG. 4A illustrates the inflight entertainment system interface 400 and an example sub-interface 402 used to display a categorized grouping of destination-specific (e.g., Rome, Italy, as shown) products, services, and/or information to passengers on an aircraft. In this particular example, the inflight entertainment system interface 400 may include controls used to access a home screen, inflight media, inflight shopping, flight information, and the like. In addition, the inflight entertainment system includes the sub-interface 402 to access the categorized grouping of destination-specific products, services, and/or information. The sub-interface 402 includes a plurality of labeled controls 404a-n linked to categorized groups of electronic offering items. The label of a control 404a-n may identify a grouping of destination-specific products, services, and/or information featured in electronic offering items. As a specific example, a control 404b labeled “Attractions” may represent a grouping of electronic offering items that feature various attractions in a destination city that correspond to an aircraft and/or passenger destination.

A passenger may navigate to a particular grouping of destination-specific products, services, and/or information featured in electronic offering items by selecting a control 404a-n that represents the categorized grouping. After selecting the control 404a-n, an example sub-interface 410, as shown in FIG. 4B, may be loaded into the inflight entertainment system interface 400. The sub-interface 410 includes a plurality of controls 412a-n linked to individual electronic offering items included in the categorized grouping. As a specific example, after selecting the control 404b labeled “Attractions” shown in FIG. 4A, the sub-interface 410 shown in FIG. 4B may be loaded into the inflight entertainment system interface 400, where the sub-interface 410 includes controls 412a-n linked to electronic offering items featuring attractions in a destination city corresponding to an aircraft and/or passenger destination.

controls 412a-n in the sub-interface 410 can display summary information for a destination-specific product, service, or information featured in an electronic offering item. As a specific example, a control 412a may display information for a tour offered in a destination city corresponding to an aircraft and/or passenger destination. The controls 412a-n enable a passenger to access the electronic offering items linked to the page controls 412a-n. As a specific example, a passenger can navigate to an electronic offering item for a tour in a destination city by selecting the control 412a that represents the electronic offering item.

FIG. 4C illustrates an example electronic offering item that can be displayed in the inflight entertainment system interface 400. A passenger can navigate to the electronic offering item 414 by selecting a control 412a-n (shown in FIG. 4B) that represents the electronic offering item. After selecting the control 412a-n, the electronic offering item 414 may be loaded into the inflight entertainment system interface 400 enabling a passenger to interact with the electronic offering item 414. As a specific example, the passenger can view a destination-specific product or service featured in the electronic offering item 414 and purchase the product or service.

It will be appreciated that the inflight entertainment system interface 400 described in association with FIGS. 4A-C can display any number of sub-interfaces and controls used to navigate categorized groupings of destination-specific electronic offering items and individual destination-specific electronic offering items. The interfaces and controls discussed and illustrated above are merely representative and are not meant to be limiting.

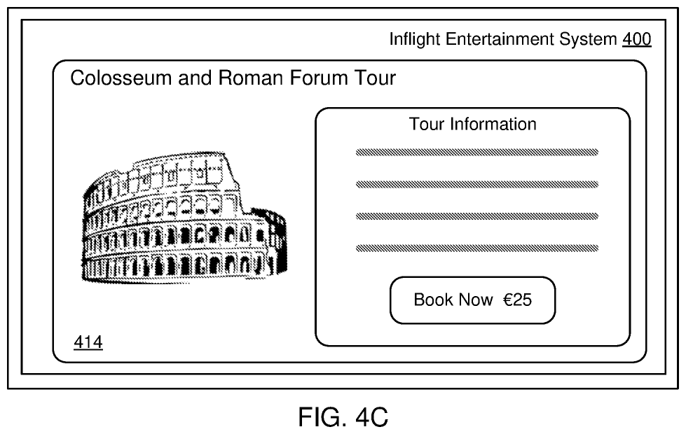

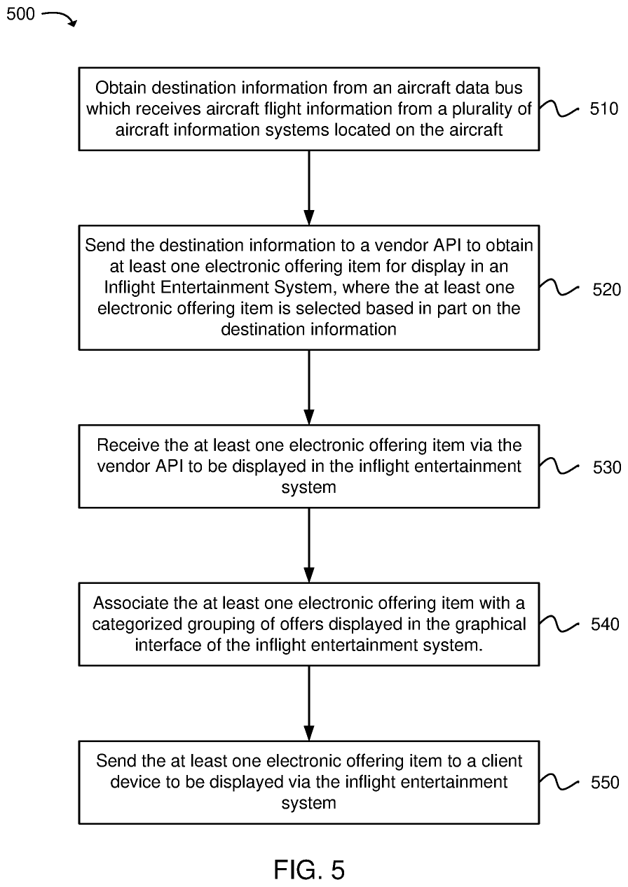

FIG. 5 is a flow diagram illustrating an example method 500 for providing electronic offering items to passengers on an aircraft. As in block 510, a server onboard the aircraft may obtain destination information from an aircraft data bus. The aircraft data bus may receive aircraft flight information from a plurality of aircraft information systems located on the aircraft. Generally speaking, aircraft flight information available from the aircraft data bus is information that is specific to the aircraft. In particular, the aircraft flight information may include an aircraft destination, such as an airport code or city name, which can be used in obtaining electronic offering items that are related in some way to the aircraft destination. In another example, a passenger destination, which may be different from an aircraft destination, may be used to obtain electronic offering items that are associated with the passenger destination.

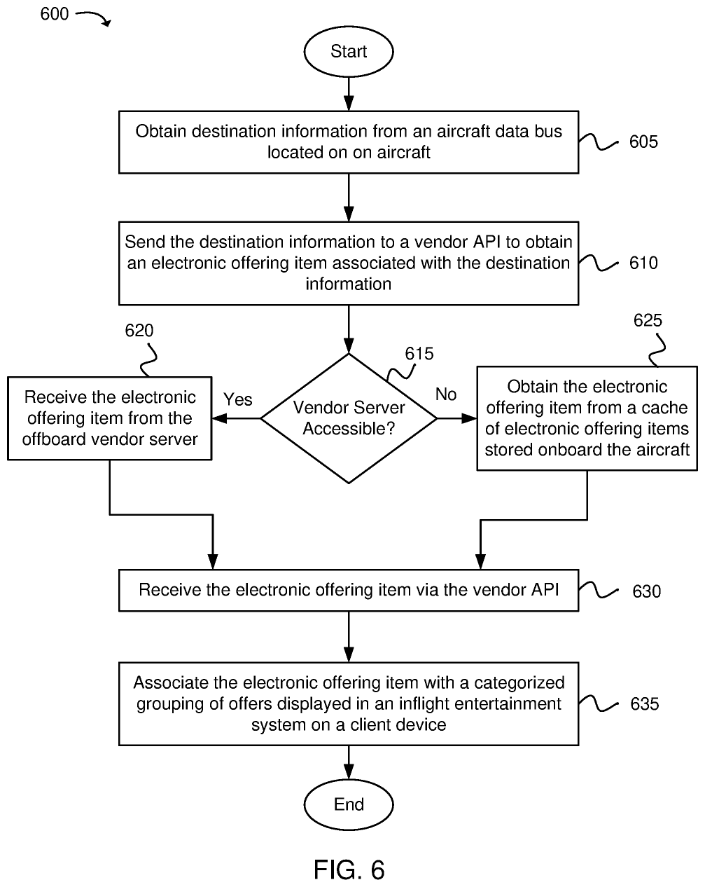

As in block 520, the onboard server may send the destination information to a vendor API (or a plurality of vendor APIs) to obtain at least one electronic offering item for display in an inflight entertainment system. In one example, the vendor API can include one or more vendor APIs for a plurality of vendor servers (e.g., for the same vendor or separate vendors) located offboard the aircraft in data centers or in other environments and locations. A vendor server may be associated with a particular vendor of a product and/or service. As an example, a vendor server and an associated vendor API may be for a tour company, a hotel, a restaurant, transportation service, and the like. In another example, the vendor API may be executed on an offboard server managed by an aircraft operator, and the vendor API may be configured to use destination information to identify vendors of products and/or services (e.g., tour companies, museums, hotels, restaurants, etc.) associated with a destination, and the API may send requests for electronic offering items to the individual vendor servers associated with the vendors. In another example described later in association with FIG. 6, the vendor API may be a local API executed on an onboard server that determines whether the vendor servers are accessible via a satellite network, and in the case that the vendor servers are not accessible, the vendor API retrieves cached electronic offering items. As will be appreciated, the vendor API can comprise combinations of the API configurations described above.

A vendor server, in response to receiving a request for an electronic offering item, uses the destination information to identify an electronic offering item stored on the vendor server that is associated with the destination information. For example, the vendor server may retrieve the electronic offering item from an offering data store using item metadata that links the electronic offering item to the destination information. The vendor server then sends the electronic offering item via the vendor API to the server located onboard the aircraft. As in block 530, the server onboard the aircraft may receive an electronic offering item via the vendor API, and as in block 540, the onboard server may associate the electronic offering item with a categorized grouping of offers. For example, the onboard server may organize the electronic offering items into categorized groupings of offers using item metadata received from the vendor servers. Electronic offering items may span a variety of categories, such as events, attractions, shopping, museums, lodging, restaurants, travel information, etc., where each category may include sub-categories. As a non-limiting example, an attractions category can include tours, entrance tickets, gift shop, transportation, and the like. The onboard server can evaluate item metadata for an electronic offering item and assign the electronic offering item to a corresponding categorized grouping.

As in block 550, the onboard server may send the electronic offering item to a client device to be displayed via an inflight entertainment system. A graphical interface of the inflight entertainment system displayed at the client device enables the passenger on the aircraft to interact with the electronic offering item (e.g., view information for a product and/or service, and purchase the product and/or service). In one example, a connection between the onboard server and the client device may be a wireless connection established via a wireless access point onboard the aircraft. In another example, the client device may be a seatback system on the aircraft, and the connection between the onboard server and the seatback system may be a wired or wireless connection.

In one example, the onboard server may be configured to determine a time to display an electronic offering item in the inflight entertainment system. As one example, the onboard server may evaluate aircraft flight information obtained from the aircraft data bus to determine a current status of a flight (e.g., parked at gate, takeoff, in-flight, time to arrival, rerouted to another destination, or landing), and the onboard server may determine whether to obtain an electronic offering item for display in the inflight entertainment system based in part on the current status of the flight. As a specific example, the onboard server may obtain destination-specific electronic offering items when the aircraft is rerouted to a new destination due to weather conditions in order to provide passengers with products and services (e.g., lodging, transportation, food services) that are available at the new destination. In another example, the onboard server may obtain a passenger profile for a passenger associated with a client device and use passenger information to select an electronic offering item to display to the passenger in the inflight entertainment system, thereby customizing or targeting the electronic offering item to the passenger.

FIG. 6 is a flow diagram that illustrates an example method 600 for providing cached electronic offering items to passengers on an aircraft when a vendor server is not available. As in block 605, a server located onboard an aircraft may obtain destination information from an aircraft bus as described previously. As in block 610, the onboard server may send the destination information to a vendor API with a request for electronic offering items which feature products, services, and/or information associated with the destination information. In this example, the vendor API may be a local API executed on the onboard server. The vendor API may be configured to obtain electronic offering items from a plurality of vendor servers located offboard the aircraft, or from a cache of electronic offering items stored onboard the aircraft when a vendor server is unavailable to fulfill requests.

As in block 615, the vendor API may be configured to determine whether one or more vendor servers are accessible via a satellite network. For example, the vendor API may send a request for an electronic offering item to a vendor server over the satellite network, and in the case that a response is not received from the vendor server within a request timeout period (e.g., 5 seconds, 30 seconds, 120 seconds, etc.), then the vendor API may determine that the vendor server is unavailable to accept the request. As in block 625, in the case that a vendor server does not respond to a request for an electronic offering item, the vendor API may obtain an electronic offering item from a cache of electronic offering items stored locally onboard the aircraft. As in block 620, in the case that the vendor server does respond to the request for the electronic offering item within the request timeout period, the vendor API receives the electronic offering item from the vendor server through the satellite network.

As in block 630, the vendor API may provide the electronic offering item to an offerings subsystem of an inflight interactive system executed on the onboard server. As in block 635, the offerings subsystem may associate the electronic offering item with a categorized grouping of offers displayed in an inflight entertainment system on a client device. For example, the offerings subsystem may assign the electronic offering item to a categorized grouping of offers using item metadata for the electronic offering item and make the electronic offering item available in the inflight entertainment system.

FIG. 7 illustrates an example of a satellite communication system 700. The satellite communication system 700 may include satellite(s) 720 in bidirectional communication with a ground station 710 via a communication link 712 between the satellite 720 and the ground station 710. The satellite 720 may also be in bidirectional communication with an aircraft 750 (e.g., an airplane, helicopter, blimp, or balloon) via a communication link 714 between the satellite 720 and the aircraft 750. The communication link 712 and the communication link 714 may enable communication between the aircraft 750 and the ground station 710 via the satellite 720 while the aircraft 750 is stationary or in motion.

In one example, the satellite communication system 700 may include multiple satellites 720, where each satellite 720 may provide coverage for a service area, and service areas for different satellites may be non-overlapping or overlapping. The satellite communication system 700 may be any suitable type of satellite system, including a geostationary satellite system, medium earth orbit satellite system, low earth orbit satellite system, or combinations thereof. The satellite 720 may have a number of beams directed at different regions on Earth, where the coverage area of each beam may be non-overlapping or overlapping with one or more other beams. The satellite 720 may have one or more spot beams covering different regions on Earth within the service area of the satellite 720. As another example, the satellite 720 may have one or more wide area coverage beams covering the service area of the satellite 720. As yet another example, the satellite 720 may have a combination of spot beams and wide area coverage beams.

In one configuration, the aircraft 750 may include a communication system 770 to facilitate bidirectional communication with the satellite 720 via the communication link 714. The communication system 770 may include an antenna 772 to receive a downlink signal from the satellite 720 and transmit an uplink signal to the satellite 720 via the communication link 714. The aircraft 750 may include a transceiver 774 in communication with the antenna 772, a modem 776 in communication with the transceiver 774, a network access unit 778 (e.g., a router) in communication with the modem 776, and a wireless access point (WAP) 780 in communication with the network access unit 778. Further, the WAP 780 may communicate with one or more client devices in the aircraft 750, such as seatback systems 785 and/or client devices 790 (e.g., mobile phones, tablets, laptops) in the aircraft 750. Therefore, the communication system 770 may receive a downlink signal from the satellite 720 and forward the downlink signal to the client devices and receive an uplink signal from the client devices and forward the uplink signal to the satellite 720, thereby supporting two-way data communications between the client devices within the aircraft 750 and the satellite 720.

In one configuration, the network access unit 778 may be in communication with a server 740 (such as the server 110 described earlier) onboard the aircraft 750. The server 740 may provide an inflight entertainment system to enable a passenger on the aircraft 750 to access a categorized grouping of electronic offering items through the inflight entertainment system. The server 740 may send the inflight entertainment system to the client device 790 onboard the aircraft 750 over a connection for display via the user interface of the client device 790. The server 740 may receive a selection of an electronic offering item included in a categorized grouping via a user interface of the inflight entertainment system. The server 740 may send the electronic offering item to the client device 790 for display on the client device 790.

In one example, the seatback system 785 may be a fixed or on-aircraft device. The seatback system 785 may communicate with the server 740 via a wired communication link. For example, the seatback system 785 may communicate with the network access unit 778 over a wired communication link, and the network access unit 778 may communicate with the server 740 over a wired communication link. Alternatively, the seatback system 785 may communicate with the server 740 via the network access unit 778 and the WAP 780. The seatback system 785 may execute one or more applications that provide an interface for passenger on the aircraft 750 to obtain and consume data.

In one example, the client device 790 may receive and display data, and may be brought onto the aircraft 750 by passengers (which includes crew members). The client devices 790 may execute one or more applications that provide the interface for passenger to obtain and consume data. The passenger may have the option to select/request data for viewing from the interface. When a passenger interacts with the client device 790, the client device 790 may transmit a request for data to the network access unit 778 via the WAP 780. The client device 790 may receive requested data from the network access unit 778 via the WAP 780. Thus, the WAP 780 may provide communication between the network access unit 778 and personal electronic device 790.

In one example, the network access unit 778 may receive requests for data from the client device 790 via the WAP 780 and multiplex and forward the requests to the modem 776. The network access unit 778 may receive and demultiplex packets associated with the data and forward the data to the client device 790 via the WAP 780.

In one example, the modem 776 may receive requests for data from the network access unit 778, and the modem 776 may generate modulated data (e.g., a transmit intermediate frequency (IF) signal) for delivery to the transceiver 774. Further, the modem 776 may receive requested data as modulated data (e.g., receive intermediate frequency (IF) signals) from the transceiver 774 and demodulate that data for transmission to the network access unit 778. In one example, the modem 776 may be integrated with the network access unit 778, or alternatively, the modem 776 and the network access unit 778 may be separate components.

In one example, the transceiver 774 may up-convert and amplify modulated data received from the modem 776 to generate an uplink signal for transmission to the satellite 720 via the antenna 772. Similarly, the transceiver 774 may receive a downlink signal from the satellite 720 via the antenna 772. The transceiver 774 may then amplify and down-convert the downlink signal to generate modulated downlink data (e.g., a received IF signal) for demodulation by the modem 776.

In one example, the ground station 710 may also be referred to as an access node, a hub, or a gateway. The ground station 710 may include an antenna to transmit an uplink signal to the satellite 720 and receive a downlink signal from the satellite 720. The ground station 710 may be in communication with a vendor server 730 via a network 760. The vendor server 730 may manage a plurality of electronic offering items, as described earlier.

In one example, the network 760 may be any type of network and may include for example, an internet, an internet protocol (IP) network, an intranet, a wide area network (WAN), local area network (LAN), a virtual private network (VPN), a virtual LAN (VLAN), a fiber optic network, a cable network, a public switched telephone network (PSTN), a public switched data network (PSDN), a public land mobile network, a cellular network, and/or any other type of network supporting communication as described herein. The network 760 may include both wired and wireless connections as well as optical links.

In one example, the ground station 710 may be provided as an interface between the network 760 and the satellite 720. The ground station 710 may receive data and information directed to the seatback system 785 and/or the client device 790 onboard the aircraft 750 from a content server 732 and vendor servers 730 accessible via the network 760. The ground station 710 may format the data and information and transmit an uplink signal to the satellite 720 for subsequent delivery to the aircraft 750 (and then the seatback system 785 and/or the client device 790). Similarly, the ground station 710 may receive a downlink signal from the satellite 720 (e.g., containing requests, data and/or information originating from the seatback system 785 and/or the client device 790 on the aircraft 750) that is directed to a destination accessible via the network 760. The ground station 710 may format the received downlink signal for transmission on the network 760.

In one configuration, the seatback system 785 and/or the client device 790 may be onboard the aircraft 750. Alternatively, the seatback system 785 and/or the client device 790 may be onboard other types of vehicles, such as trains, automobiles (e.g., cars, trucks, busses, etc.), watercraft (e.g., private boats, commercial shipping vessels, cruise ships, etc.) and others.

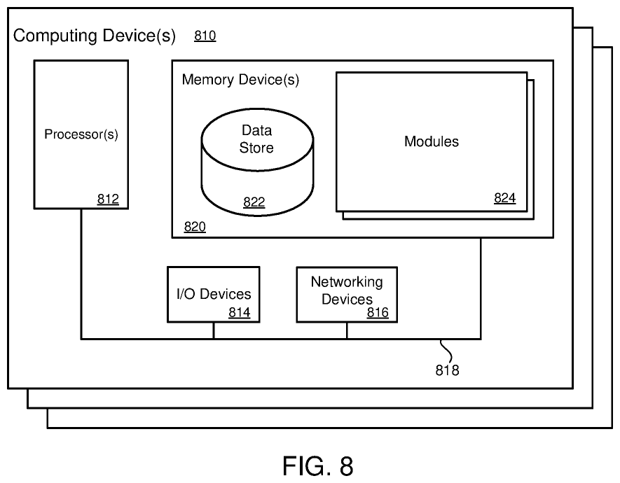

FIG. 8 illustrates a computing device 810 which may execute the foregoing subsystems of this technology. The computing device 810 and the components of the computing device 810 described herein may correspond to the servers and/or client devices described above. The computing device 810 is illustrated on which a high-level example of the technology may be executed. The computing device 810 may include one or more processors 812 that are in communication with one or more memory devices 820. The computing device may include a local communication interface 818 for the components in the computing device. For example, the local communication interface may be a local data bus and/or any related address or control busses as may be desired.

The memory device 820 may contain modules 824 that are executable by the processor(s) 812 and data for the modules 824. For example, the memory device 820 may include an inflight interactive system module, an offerings subsystem module, a passenger profile subsystem module, and other modules. The modules 824 may execute the functions described earlier. A data store 822 may also be located in the memory device 820 for storing data related to the modules 824 and other applications along with an operating system that is executable by the processor(s) 812.

Other applications may also be stored in the memory device 820 and may be executable by the processor(s) 812. Components or modules discussed in this description that may be implemented in the form of software using high programming level languages that are compiled, interpreted, or executed using a hybrid of the methods.

The computing device may also have access to I/O (input/output) devices 814 that are usable by the computing devices. An example of an I/O device is a display screen that is available to display output from the computing devices. Other known I/O device may be used with the computing device as desired. Networking devices 816 and similar communication devices may be included in the computing device. The networking devices 816 may be wired or wireless networking devices that connect to the internet, a LAN, WAN, or other computing network.

The components or modules that are shown as being stored in the memory device 820 may be executed by the processor 812. The term “executable” may mean a program file that is in a form that may be executed by a processor 812. For example, a program in a higher-level language may be compiled into machine code in a format that may be loaded into a random-access portion of the memory device 820 and executed by the processor 812, or source code may be loaded by another executable program and interpreted to generate instructions in a random-access portion of the memory to be executed by a processor. The executable program may be stored in any portion or component of the memory device 820. For example, the memory device 820 may be random access memory (RAM), read only memory (ROM), flash memory, a solid-state drive, memory card, a hard drive, optical disk, floppy disk, magnetic tape, or any other memory components.

The processor 812 may represent multiple processors and the memory device 820 may represent multiple memory units that operate in parallel to the processing circuits. This may provide parallel processing channels for the processes and data in the system. The local interface 818 may be used as a network to facilitate communication between any of the multiple processors and multiple memories. The local interface 818 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom Very Large Scale Integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices. The modules may be passive or active, including agents operable to perform desired functions.

The technology described here can also be stored on a computer readable storage medium that includes volatile and non-volatile, removable, and non-removable media implemented with any technology for the storage of information such as computer readable instructions, data structures, program modules, or other data. Computer readable storage media include, but is not limited to, RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

In describing the present technology, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide.

Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A system for providing electronic offering items to passengers on an aircraft, comprising:
at least one processor; and
a memory device including instructions that, when executed by the at least one processor, cause the system to:
obtain destination information from an aircraft data bus, wherein the aircraft data bus receives aircraft flight information from a plurality of aircraft information systems located on the aircraft;
send the destination information to at least one vendor application programming interface (API) to obtain at least one electronic offering item for display in an inflight entertainment system, wherein the at least one electronic offering item is selected based in part on the destination information;
receive the at least one electronic offering item to be displayed in the inflight entertainment system; and
send the at least one electronic offering item to a client device to be displayed via the inflight entertainment system, wherein a graphical interface of the inflight entertainment system at the client device enables a passenger on the aircraft to interact with the at least one electronic offering item.

2. The system of claim 1, wherein a vendor API is for a vendor server, and the vendor API is configured to:
retrieve an electronic offering item having metadata that links the electronic offering item to the destination information from an offering data store; and
send the electronic offering item to be displayed in the inflight entertainment system.

3. The system of claim 2, wherein the vendor server is located off the aircraft and communication with the vendor server is performed over a satellite network.

4. The system of claim 2, wherein the memory device further includes instructions that, when executed by the at least one processor, cause the system to:
obtain an electronic offering item from a cache of electronic offering items stored on a data store located on the aircraft when communication with the vendor server cannot be established.

5. The system of claim 1, wherein the memory device further includes instructions that, when executed by the at least one processor, cause the system to:
associate an electronic offering item with a categorized grouping of offers displayed in the graphical interface of the inflight entertainment system.

6. The system of claim 1, wherein the memory device further includes instructions that, when executed by the at least one processor, cause the system to:
evaluate the aircraft flight information to determine a current status of a flight; and
determine whether to obtain an electronic offering item for display in the inflight entertainment system based in part on the current status of the flight.

7. The system of claim 1, wherein the memory device further includes instructions that, when executed by the at least one processor, cause the system to:
obtain interaction data for passenger interaction with the inflight entertainment system; and
determine whether to obtain an electronic offering item for display in the inflight entertainment system based in part on the interaction data.

8. The system of claim 1, wherein the memory device further includes instructions that, when executed by the at least one processor, cause the system to:
obtain a passenger profile for the passenger associated with the client device; and
send passenger information in the passenger profile to the vendor API to allow the passenger information to be used in part to select the at least one electronic offering item to be displayed to the passenger in the inflight entertainment system.

9. The system of claim 1, wherein the aircraft flight information includes: an aircraft origin, an aircraft destination, a passenger destination, an estimated arrival time, an arrival gate, a current latitude and longitude of the aircraft, a current aircraft speed, a current aircraft altitude, a seatbelt warning status, a passenger service status, or an origin weather report.

10. The system of claim 1, wherein a network connection between the system and the client device is a wireless connection established via a wireless access point onboard the aircraft.

11. The system of claim 1, wherein the client device is a seatback system on the aircraft, and a connection between a server on the aircraft and the seatback system is a wired or wireless connection.

12. The system of claim 1, wherein the client device is a personal electronic device.

13. A computer implemented method, comprising:
obtaining destination information from an aircraft data bus of an aircraft, wherein the aircraft data bus receives aircraft flight information from a plurality of aircraft information systems located on the aircraft;
sending the destination information to a vendor application programming interface (API) to obtain at least one electronic offering item for display in an inflight entertainment system, wherein the at least one electronic offering item is selected based in part on the destination information;
receiving the at least one electronic offering item via the vendor API to be displayed in the inflight entertainment system; and
sending the at least one electronic offering item to a client device to be displayed via the inflight entertainment system, wherein a graphical interface of the inflight entertainment system at the client device enables a passenger on the aircraft to interact with the at least one electronic offering item.

14. The method of claim 13, wherein the vendor API is for a vendor server, and the vendor API is configured to:
retrieve an electronic offering item having metadata that links the electronic offering item to the destination information from an offering data store; and
send the electronic offering item to be displayed in the inflight entertainment system.

15. The method of claim 14, wherein the vendor server is located off the aircraft and communication with the vendor server is performed over a satellite network.

16. The method of claim 14, further comprising:
obtaining an electronic offering item from a cache of electronic offering items stored on the aircraft when communication with the vendor server cannot be established.

17. The method of claim 13, further comprising:
associating an electronic offering item with a categorized grouping of offers displayed in the graphical interface of the inflight entertainment system.

18. The method of claim 13, further comprising:
evaluating the aircraft flight information to determine a current status of a flight; and
determining whether to obtain an electronic offering item for display in the inflight entertainment system based in part on the current status of the flight.

19. The method of claim 13, further comprising:
obtaining interaction data from passenger interaction with the inflight entertainment system; and
determining whether to obtain an electronic offering item for display in the inflight entertainment system based in part on the interaction data.

20. The method of claim 13, further comprising:
obtaining a passenger profile for the passenger associated with the client device; and
sending passenger information in the passenger profile to the vendor API to allow the passenger information to be used to select an electronic offering item to be displayed to the passenger in the inflight entertainment system.

21. The method of claim 13, wherein the aircraft flight information includes: an aircraft origin, an aircraft destination, a passenger destination, an estimated arrival time, an arrival gate, a current latitude and longitude of the aircraft, a current aircraft speed, a current aircraft altitude, a seatbelt warning status, a passenger service status, or an origin weather report.

22. The method of claim 13, wherein a network connection used to communicate with the client device is a wireless connection established via a wireless access point onboard the aircraft.

23. The method of claim 13, wherein the client device is a seatback system on the aircraft, and a connection between a server on the aircraft and the seatback system is a wired or wireless connection.

24. The method of claim 13, wherein the client device is a personal electronic device.

25. A non-transitory machine readable storage medium including instructions embodied thereon, wherein the instructions, when executed by at least one processor:
obtain destination information from an aircraft data bus of an aircraft, wherein the aircraft data bus receives aircraft flight information from a plurality of aircraft information systems located on the aircraft;
send the destination information to a vendor application programming interface (API) to obtain at least one electronic offering item for display in an inflight entertainment system, wherein the at least one electronic offering item is selected based in part on the destination information;
receive the at least one electronic offering item to be displayed in the inflight entertainment system; and
send the at least one electronic offering item to a client device to be displayed via the inflight entertainment system, wherein a graphical interface of the inflight entertainment system at the client device enables a passenger on the aircraft to interact with the at least one electronic offering item.

26. The non-transitory machine readable storage medium of claim 25, wherein the vendor API is for a vendor server, and the vendor API is configured to:
retrieve an electronic offering item having metadata that links the electronic offering item to the destination information from an offering data store; and
send the electronic offering item to be displayed in the inflight entertainment system.

27. The non-transitory machine readable storage medium of claim 26, wherein the vendor server is located off the aircraft and communication with the vendor server is performed over a satellite network.

28. The non-transitory machine readable storage medium of claim 26, further comprising instructions, that when executed by the at least one processor:
obtain an electronic offering item from a cache of electronic offering items stored on the aircraft when communication with the vendor server cannot be established, wherein the cache of electronic offering items is accessed through the vendor API.

29. The non-transitory machine readable storage medium of claim 25, further comprising instructions, that when executed by the at least one processor:
associate an electronic offering item with a categorized grouping of offers displayed in the graphical interface of the inflight entertainment system.

30. The non-transitory machine readable storage medium of claim 25, further comprising instructions, that when executed by the at least one processor:
evaluate the aircraft flight information to determine a current status of a flight; and
determine whether to obtain an electronic offering item for display in the inflight entertainment system based in part on the current status of the flight.

31. The non-transitory machine readable storage medium of claim 25, further comprising instructions, that when executed by the at least one processor:
obtain interaction data associated with passenger interaction with the inflight entertainment system; and
determine whether to obtain an electronic offering item for display in the inflight entertainment system based in part on the interaction data.

32. The non-transitory machine readable storage medium of claim 25, further comprising instructions, that when executed by the at least one processor:
obtain a passenger profile for a passenger associated with the client device; and
send passenger information in the passenger profile to the vendor API to allow the passenger information to be used to select an electronic offering item to be displayed to the passenger in the inflight entertainment system.

33. The non-transitory machine readable storage medium of claim 25, wherein the aircraft flight information includes: an aircraft origin, an aircraft destination, a passenger destination, an estimated arrival time, an arrival gate, a current latitude and longitude of the aircraft, a current aircraft speed, a current aircraft altitude, a seatbelt warning status, a passenger service status, or an origin weather report.

34. The non-transitory machine readable storage medium of claim 25, wherein a network connection between the system and the client device is a wireless connection established via a wireless access point onboard the aircraft.

35. The non-transitory machine readable storage medium of claim 25, wherein the client device is a seatback system on the aircraft, and a connection between a server on the aircraft and the seatback system is a wired or wireless connection.

36. The non-transitory machine readable storage medium of claim 25, wherein the client device is a personal electronic device.
